(19) United States
(12) Patent Application Publication
(10) Pub. No.: US 2008/0150479 A1
(43) Pub. Date: Jun. 26, 2008

(54) ELECTRIC CHARGING DEVICE FOR PORTABLE TERMINAL

(76) Inventors: Shin-Hee Cho, Suwon-si (KR); Yong-Gu Lee, Bucheon-si (KR); Jea-Hyuck Lee, Anyang-si (KR); Jae-Young Huh, Seoul (KR); Ji-Hyun Jung, Gwangju-si (KR)

Correspondence Address: CHA & REITER, LLC, 210 ROUTE 4 EAST STE 103, PARAMUS, NJ, 07652, US

(21) Appl. No.: 11/960,783

(22) Filed: Dec. 20, 2007

(30) Foreign Application Priority Data
Dec. 22, 2006 (KR) 132705/2006

(51) Int. Cl. H02J 7/00

(52) U.S. Cl. 320/113

(57) ABSTRACT

An electric charging device for a portable terminal includes a charging circuit and a switching unit electrically connected with the charging circuit, in which the switching unit turns on/off power supplied to the charging circuit according to whether the electric charging device is connected to the portable terminal or a battery cradle for the portable terminal. The electric charging device can reduce unnecessary power consumption by being disconnected from the external power source when not being connected to the portable terminal or the battery cradle. Moreover, the electric charging device itself has a power saving function by being disconnected from the external power source when not being connected to the portable terminal or the battery cradle.

### CLAIM OF PRIORITY

This application claims priority of an earlier Korean Patent Application, entitled Electric Charging Device for Portable Terminal, filed in the Korean Intellectual Property Office on Dec. 22, 2006 and assigned Serial No. 2006-132705, the entire disclosure of which is hereby incorporated by reference.

### BACKGROUND OF THE INVENTION

1. Field of the Invention

The present invention generally relates to a portable terminal, and in particular, to an electric charging device for a portable terminal.

2. Description of the Related Art

A portable terminal typically includes Personal Digital Assistants (PDA), Global Positioning System (GPS) terminal, mobile communication terminals, and the like. As the portability of notebook computers has improved in size and equipped with advance wireless communication technology, users can now enjoy the multimedia functions, such as movie watching or connecting to the Internet.

Providing a stable power source to a user while on the move becomes a major criterion in selecting a portable terminal. The power sources of the portable terminals generally use a chargeable battery. As the portable terminals have been miniaturized, it becomes difficult to secure a sufficient capacity when using the chargeable battery. Thus, the user has to carry a spare chargeable battery to secure a sufficient power source while on the move or an electric charger.

When the electric charging device for the conventional portable terminal is connected to an external power source, the power source is supplied to an electric charging circuit and may cause unnecessary power consumption sometime since the electric charging occurs even though it does not charge the battery pack mounted in the portable terminal or mounted in a cradle. To avoid unnecessary power consumption, the user has to manually disconnect the electric charging device from an external power source when charging is not required.

### SUMMARY OF THE INVENTION

The present invention provides an electric charging device for a portable terminal, which is disconnected from an external power source when not being connected to the portable terminal or a battery cradle, thereby minimizing unnecessary power consumption.

Another aspect of the present invention is to provide an electric charging device for a portable terminal, which is disconnected from an external power source when not being connected to the portable terminal or a battery cradle, thereby minimizing the user's inconvenience of connecting the electric charging device to or disconnecting the electric charging device from the external power source to save power.

According to one aspect of the present invention, an electric charging device for a portable terminal includes a charging circuit and a switching unit electrically connected with the charging circuit, in which the switching unit turns on/off power supplied to the charging circuit according to whether the electric charging device is connected to the portable terminal or a battery cradle for the portable terminal.

### BRIEF DESCRIPTION OF THE DRAWINGS

The above features and advantages of an exemplary embodiment of the present invention will be more apparent from the following detailed description taken in conjunction with the accompanying drawings, in which:

FIG. 1 is a perspective view of an electric charging device for a portable terminal according to an exemplary embodiment of the present invention;

FIGS. 2 and 3 are views for explaining various forms of an electric charging device illustrated in FIG. 1;

FIG. 4 is a view for explaining an example of a switching unit for electric charging devices illustrated in FIGS. 2 and 3; and

FIG. 5 is a view for explaining an operation of an electric charging device for a portable terminal illustrated in FIG. 1.

### DETAILED DESCRIPTION OF THE PRESENT INVENTION

The matters defined in the description such as a detailed construction and elements are provided to assist in a comprehensive understanding of an exemplary embodiment of the invention. Accordingly, those of ordinary skill in the art will recognize that various changes and modifications of the embodiment described herein can be made without departing from the scope and spirit of the invention. Also, descriptions of well-known functions and constructions are omitted for clarity and conciseness.

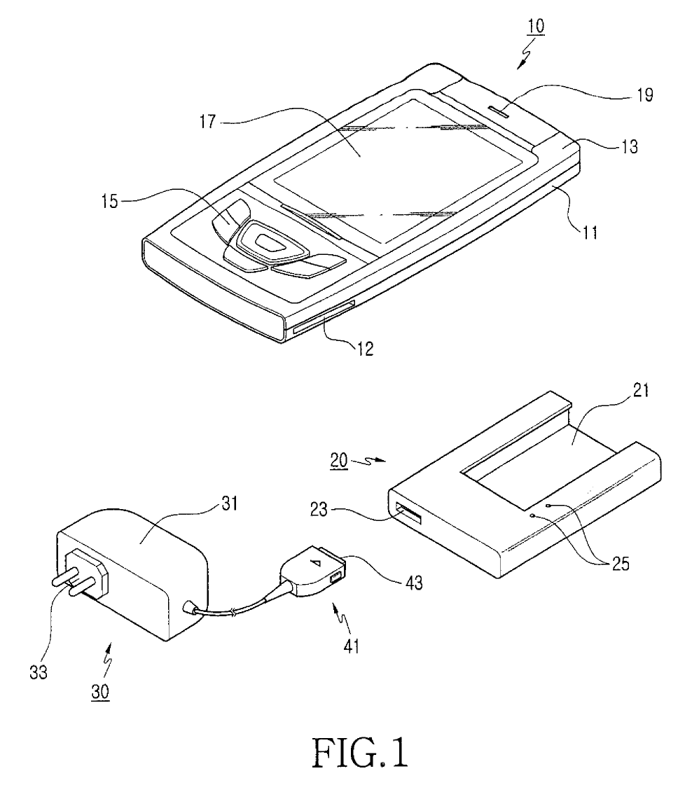

Referring to FIG. 1, an electric charging device 30 according to an exemplary embodiment of the present invention includes a circuit housing 31 having a charging circuit and a connector 41 detachably coupled to a portable terminal 10 or a battery cradle 20. The circuit housing 31 includes a plug 33 for connection to an external power source, more specifically an outlet. A connection end 43 is installed at an end portion of the connector 41 to be electrically connected directly to the portable terminal 10 or the battery cradle 20.

Although a portable phone among various types of electronic devices will be taken as an example of the portable terminal 10 in the current exemplary embodiment of the present invention, any type of terminal supplied with power using a chargeable battery can use the electric charging device 30 according to the teachings of the present invention.

The portable terminal 10 is of a sliding type in which a second housing 13 that reciprocates along a straight line while facing a first housing 11. It should be noted the sliding type terminal is shown in for illustrative purposes, but other types of portable terminal designs can be incorporated in compliance of the present invention. As the second housing 13 slides, a keypad (not shown) installed in the first housing 11 is opened or closed. A functional keypad 15, display device 17, and reception unit 19 (or an earpiece) are installed on one face of the second housing 13 and a battery pack (not shown) is accommodated in the first housing 11.

A connector socket 12 is installed at one side face of the portable terminal 10 for connection with the electric charging device 30. The connector socket 12 may also be connected to a separate connection cable (not shown). The separate connection cable connects the portable terminal 10 to other types of electronic devices, e.g., a personal computer. By connecting the portable terminal 10 to the electronic device using the connection table, the user can move information stored in the portable terminal 10 to another electronic device or perform software upgrade.

The battery cradle 20 is an accessory for directly charging the battery packet without using the portable terminal 10. A mounting recess 21 for mounting the battery pack is formed at one face of the battery cradle 20, and a connector socket 23 for connection with the connector 41 of the electric charging device 30 is formed at one end of the battery cradle 20.

A charging indication lamp 25 may be provided in the battery cradle 20. In the current exemplary embodiment of the present invention, the charging indication lamp 25 is installed adjacent to the mounting recess 21. In an alternate embodiment, the charging indication lamp 25 may be provided in the connector 41 of the electric charging device 30 instead of in the battery cradle 20. If the charging indication lamp 25 is installed in the connector 41, the user can check the charging state of the battery pack when the battery pack mounted in the portable terminal 10 is being charged.

Referring to FIG. 5, the electric charging device 30 includes a charging circuit 35 and a switching unit 50 that are embedded in the circuit housing 31. The charging circuit 35 converts Alternate Current (AC) power, supplied to the public, to Direct Current (DC) power so that the AC power can have a voltage and a current suitable for battery charging.

The charging circuit 35 is connected to an external power source through a pair of power lines 37 and 39 connected to the plug 33. One of the power lines 37 and 39 is directly connected to the charging circuit 35, and the other is connected to the charging circuit 35 via the switching unit 50. The switching unit 50 turns on or off a power source supplied to the charging circuit 35 according to whether the electric charging device 30 is connected to the portable terminal 10 or the battery cradle 20.

A first line 39a of the power line 39 is connected to the external power source, and a second line 39b of the power line 39 is connected to the charging circuit 35. The switching unit 50 electrically connects/disconnects the first line 39a and the second line 39b to/from each other.

The switching unit 50 may be installed in any one of the connector 41 of the electric charging device 30, the portable terminal 10, and the battery cradle 20. However, the switching unit 50 should be installed in the portable terminal 10 and the battery cradle 20 when not being installed in the connector 41, and should not be installed in the portable terminal 10 and the battery terminal 20 when being installed in the connector 41.

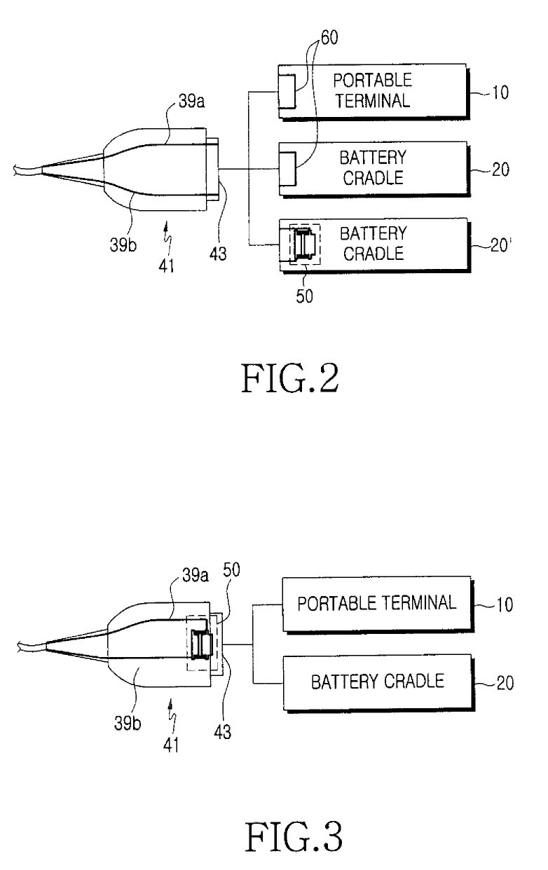

FIG. 2 illustrate the structure of the switching unit 50 installed in the portable terminal 10 and the battery cradles 20 and 20′ according to one embodiment, and FIG. 3 illustrates the structure of the switching unit 50 installed in the connector 41 according to another embodiment of the present invention.

In FIG. 2, the switching unit 50 is provided in the portable terminal 10 the battery cradles 20 and 20′. The switching unit 50 provided in the portable terminal 10 and the battery cradles 20 and 20′ may be implemented with a simple power connection line 60, or may include a fixed member 51 and a movable member 53 a shown in FIG. 5.

If the switching unit 50 is implemented with the power connection line 60 in the portable terminal 10, the first line 39a and the second line 39b of the power line 39 are electrically connected to each other by the power connection line 60 when the connector 41 is connected to the portable terminal 10 or the battery cradles 20 and 20′. In this case, both the power line 37 directly connects to the charging circuit 35 and the power line 39 passing through the switching unit 50 connects the charging circuit 35 to the external power source, thereby supplying power to the charging circuit 35 to enable the charging of the battery pack.

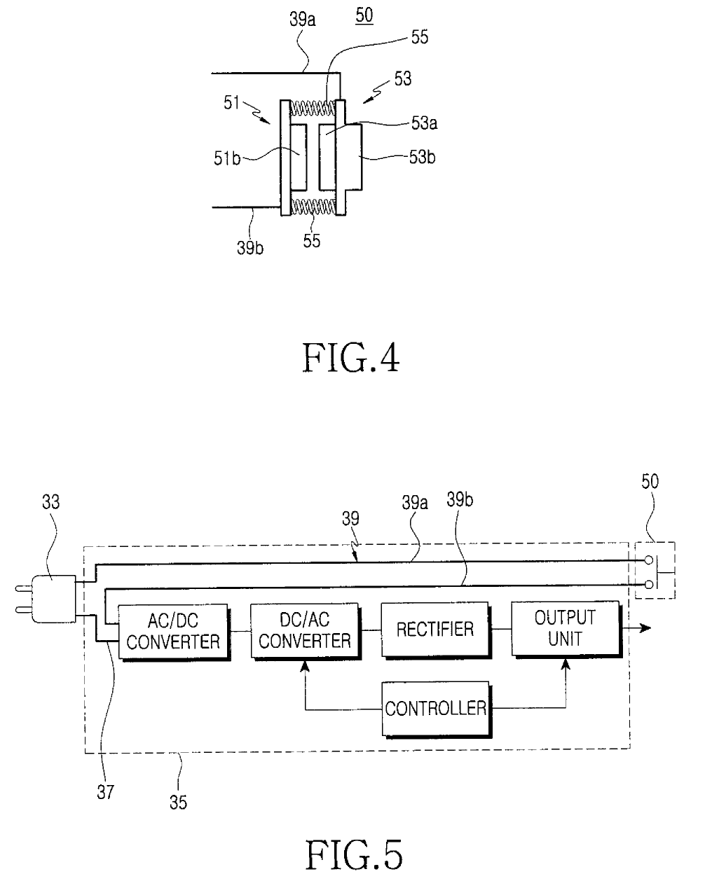

If the switching unit 50 provided in the battery cradle 20 is implemented with the power connection unit 60, power can be supplied to the charging circuit 35 even when the battery pack is not mounted in the mounting recess 21. This means that the charging circuit 35 consumes power even when charging is not conducted in the battery cradle 20. This can be avoided by configuring the switching unit 50 installed in the battery cradles 20 and 20 with a fixed member 51 and a movable member 53 instead of the power connection line 60. Thus, unnecessary power consumption can be prevented when the connector 41 is connected to the battery cradles 20 and 20′. The switching unit 50 provided with a fixed member 51 and a movable member 53 is illustrated in FIG. 4.

Referring to FIG. 4, the switching unit 50 includes a fixed member 51 fixed in the battery cradle 20 and a movable member 53 installed in such a way to reciprocate along a straight line in the battery cradle 20. When the connector 41 is connected to the battery cradle 20, the movable member 53 installed in the battery cradle 20 is connected to the external power source by the first line 39a and the fixed member 51 is connected to the charging circuit 35 by the second line 39b. When the battery pack is mounted in the battery cradle 20, the movable member 53 interferes with the mounted battery pack, thus contacting the fixed member 51. In this way, the first line 39a and the second line 39b are electrically connected to each other.

The fixed member 51 includes a contact end 51b protruding towards the movable member 53, and the movable member 53 also includes a contact end 53a protruding towards the fixed member 51. The movable member 53 also includes an interference protrusion 53b protruding in the opposite direction to the protruding direction of the contact end 53a. Once the battery pack is mounted in the battery cradle 20, the interference protrusion 53b interferes with the battery pack and thus moves back towards the fixed member 51. As a result, the contact ends 51b and 53a contact each other, thereby connecting the first line 39a and the second line 39b to each other.

When the battery pack is not mounted in the battery cradle 20, the movable member 53 moves away from the fixed member 51, thereby electrically disconnecting the first line 39a and the second line 39b from each other. When the battery pack is not mounted in the battery cradle 20, an elastic member 55 may be interposed between the fixed member 51 and the movable member 53 so that the movable member 53 can be maintained spaced apart from the fixed member 51. The elastic member 55 provides an elastic force that works in a direction for moving the fixed member 51 and the movable member 53 away from each other.

At this time, the fixed member 51 and the movable member 53 are physically connected with each other by means of the battery cradle 20 and the elastic member 55, but have to be maintained electrically disconnected from each other. Therefore, it is preferable that the remaining portions of the fixed member 51 and the movable member 53 except for portions that directly contact each other be made of an insulating material. Additionally, the first line 39a and the second line 39b extend to the inside of the fixed member 51 and the movable member 53 to be connected to the portions of the fixed member 51 and the movable member 53 that directly contact each other.

In this way, by configuring the switching unit 50 installed in the battery cradle 20 with the fixed member 51 and the movable member 53, the power supply to the charging circuit 35 can be prevented when the battery pack is not mounted in the battery cradle 20.

Referring to FIG. 3, the switching unit 50 is connected to the connector 41. The switching unit 50 illustrated in FIG. 3 has the same structure as the switching unit 50 illustrated in FIG. 5 by including the fixed member 51 and the movable member 53, thus its detailed description will not be given herein to avoid redundancy.

Once the connector 41 is connected to the portable terminal 10 or the battery cradle 20, the movable member 53 interferes with the portable terminal 10 or the battery cradle 20 and thus contacts the fixed member 51. As a result, the first line 39a and the second line 39b are electrically connected to each other and thus power is supplied to the charging circuit 35. When the switching unit 50 provided with the fixed member 51 and the movable member 53 is installed in the connector 41, the power can be supplied to the charging circuit 35 when the connector 41 is coupled to the portable terminal 10 or the battery cradle 20.

As described with reference to FIGS. 2 and 3, the switching unit 50 using the power connection line 60 is installed in the portable terminal 10, and the switching unit 50 using the fixed member 51 and the movable member 53 is installed in the battery cradle 20, thereby preventing an increase in manufacturing cost and providing an improved power saving. For a greater cost reduction than the power consumption, only a single switching unit 50 using the fixed member 51 and the movable member 53 may be installed in the connector unit 41, or the switching unit 50 using the power connection line 60 may be installed in the portable terminal 10 and the battery cradle 20.

It should be noted that a simple switching unit can be configured without using the fixed member 51 and the movable member 53 by installing a third line and a fourth line (not shown) in the battery cradle 20 to extend the first line 39a and the second line 39b when the connector 41 is connected to the battery cradle 20 and installing another power connection line using a flexible printed circuit in the battery pack to be mounted in the battery cradle 20, thereby improving both cost reduction and power saving.

As discussed above, the electric charging device for the portable terminal has the switching unit between the external power source and the charging circuit and thus is disconnected from the external power source when not being connected to the portable terminal or the battery cradle, thereby reducing unnecessary power consumption.

Moreover, the electric charging device itself has a power saving function by being disconnected from the external power source when not being connected to the portable terminal or the battery cradle, thereby reducing user's inconvenience of connecting/disconnecting the electric charging device to/from the external power source for power saving.

While the invention has been shown and described with reference to an exemplary embodiment thereof, it will be understood by those skilled in the art that various changes in form and details may be made therein without departing from the spirit and scope of the invention.

What is claimed is:

1. An electric charging device for a portable terminal, comprising:
a charging circuit; and
a switching unit electrically coupled to the charging circuit,
wherein the switching unit turns on/off power supplied to the charging circuit according to whether the electric charging device is coupled to the portable terminal or a battery cradle for the portable terminal.

2. The electric charging device of claim 1, wherein one of a pair of power lines for supplying an external power source is directly connected to the charging circuit and the other is connected to the charging circuit via the switching unit.

3. The electric charging device of claim 2, further comprising:
a circuit housing coupled to an outlet of the external power source; and
a connector selectively coupled to the portable terminal or the battery cradle,
wherein the charging circuit is provided in the circuit housing, and the switching unit is provided in the portable terminal and the battery cradle.

4. The electric charging device of claim 3, wherein a first line of a power line passing through the switching unit is coupled to the external power source, a second line of the power line is coupled to the charging circuit, and the switching unit is provided with a power connection line that connects the first line and the second line to each other.

5. The electric charging device of claim 3, wherein the switching unit installed in the battery cradle comprises:
a fixed member fixed in the battery cradle;
a movable member installed in such a way to reciprocate along a straight line in the battery cradle and to selectively contact the fixed member; and
an elastic member between the fixed member and the movable member to keep the fixed member and the movable member spaced apart from each other,
wherein the movable member contacts the fixed member when a battery pack for the portable terminal is mounted in the battery cradle.

6. The electric charging device of claim 5, wherein a first line of a power line passing through the switching unit connects the external power source and the movable member to each other, and a second line of the power line connects the charging circuit and the fixed member to each other.

7. The electric charging device of claim 1, further comprising:
a circuit housing coupled to a plug of an external power source; and
a connector selectively coupled to the portable terminal or the battery cradle,
wherein the charging circuit is provided in the circuit housing and the switching unit is provided in the connector.

8. The electric charging device of claim 7, wherein one of a pair of power lines for supplying an external power source is directly coupled to the charging circuit, and the other is coupled to the charging circuit via the switching unit.

9. The electric charging device of claim 8, wherein the switching unit comprises:
a fixed member fixed in the connector;
a movable member installed in such a way to reciprocate along a straight line in the connector and to selectively contact the fixed member; and
an elastic member between the fixed member and the movable member to keep the fixed member and the movable member spaced apart from each other,
wherein the movable member contacts the fixed member when the connector is coupled to the portable terminal or the battery cradle.

10. The electric charging device of claim 9, wherein the movable member interferes with the portable terminal or the battery cradle and thus contacts the fixed member when the connector is selectively coupled to the portable terminal or the battery cradle.

11. The electric charging device of claim 9, wherein a first line of a power line passing through the switching unit connects the external power source and the movable member to each other, and a second line of the power line connects the charging circuit and the fixed member to each other.

12. The electric charging device of claim 1, further comprising a charging indication lamp provided in the battery cradle.

13. The electric charging device of claim 1, further comprising a charging indication lamp provided in the electric charging device.

14. The electric charging device of claim 1, wherein electric charging device being selectively disconnected from an external power source when not being connected to the portable terminal or the battery cradle.
